(19) United States
(12) Patent Application Publication
(10) Pub. No.: US 2018/0132022 A1
(43) Pub. Date: May 10, 2018

(54) APPLIANCE INTEGRAL AND ANCILLARY TO THE FUNCTION OF A FOOT APPAREL.

(71) Applicant: Gary O. Sandstedt, St. Louis, MO (US)

(72) Inventor: Gary O. Sandstedt, St. Louis, MO (US)

(21) Appl. No.: 15/348,482

(22) Filed: Nov. 10, 2016

(51) Int. Cl. H04R 1/02; A43B 3/00; A43C 7/00; F21V 33/00; F21L 4/08

(52) U.S. Cl. CPC H04R 1/028; A43B 3/001; A43B 3/0021; A43C 7/00; F21Y 2115/10; F21L 4/08; H04R 2201/023; H04R 2201/028; F21V 33/0008

(57) ABSTRACT

This invention describes a lace pinching appliance, to eliminate bow tie knotting which secures a foot apparel in place, and hosts a platform supporting a multi-function means of communication.

### BACKGROUND OF THIS INVENTION

Decorated shoes have long been available, and light emitting diodes, and functions to monitor exercising are now incorporated into running shoes.

This invention comprises a sound recording, and playback system, an array of light emitting diodes, wireless radio frequency communications, and the elimination of bow tie knotting, all as a single entity, integrated into, and ancillary to the normal function of a shoe, or other foot worn apparel.

### OBJECTS OF THIS INVENTION

1. To communicate by recording, and playing back audio sounds, using a mechanism, hosted by foot worn apparel.

2. To communicate using light emitting diodes, hosted by foot worn apparel.

3. To communicate through a radio frequency system, hosted by foot worn apparel.

4. To provide a fast, convenient, and simple way to secure foot worn apparel, by eliminating bow tie knotting.

### PRIOR ART CITED

To date, foot worn apparel has not been a host of visual, sound, or wireless radio frequency communication as a single entity.

Additionally, in combination with visual, sound and wireless radio frequency communication, foot worn apparel has not been a host to the elimination of bow tie knotting.

Velcro straps, mechanical clamping devices, zippers, buckles, hooks, and elastic bands integral to foot worn apparel, are alternatives to bow tie knotting of lacing strings.

Liu patent 6,510,627 B1, dated 28 Jan. 2003; Curet patent 6,725,575 B2, dated 27 Apr. 2004; and Cheng patent 7,574,786 B2, dated 18 Aug. 2009, all cite different mechanical configurations for securing a shoe lacing string in place, in lieu of bow tie knotting, with the common denominator of each being a basic clamping means.

Liu patent 6,510,627 B1, describes a mechanical pressure clamp device securing a shoe lacing string in lieu of bow tie knotting.

Curet patent, 6,725,575 B2 describes a mechanical pressure clamp device securing a shoe lacing string in lieu of bow tie knotting.

Cheng patent 7,,574,786 B2, describes a mechanical pressure clamp device securing a shoe lacing string, in lieu of bow tie knotting.

Forbes patent 7,866,066 B1, describes another such example of a light emitting diode configuration as part of a shoe.

### IN SUMMATION

Prior art does not disclose a single push-button lace tying means, along with light emitting diode, sound, and wireless radio frequency comunications, all of which are combined, as a single entity integral, and ancillary to the function of a shoe, or other foot worn apparel.

### FEATURES OF THIS INVENTION INCLUDE

A. A means to communicate visually using an appliance integral and ancillary to the function of a shoe, or other foot worn apparel.

B. A means to communicate by radio frequency using an appliance integral and ancillary to the function of a shoe, or other foot apparel.

C. A means to communicate by sound using an appliance integral and ancillary to the function of a shoe, or other foot worn apparel.

D. A single push-button means of securing wearing apparel on a foot, in combination with other ancillary functions.

### BRIEF DESCRIPTION OF THE DRAWINGS

FIG. 1, profiles a clamping means that eliminates bow tie knotting, while securing a shoe, or other foot apparel, on a wearer.

FIG. 2, shows a multi-function electronic system secured to a shoe.

FIG. 3, shows a profile o FIG. 2.

FIG. 4, shows a block diagram depicting the battery and solar powered functions of this invention.

### DESCRIPTION OF AN EMBODIMENT

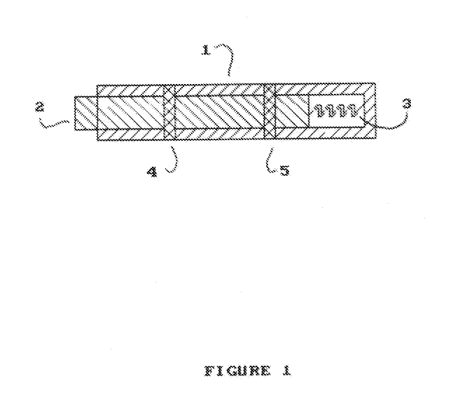

FIG. 1, shows a profile of enclosure 1, with plunger 2, and compression-expansion spring 3.

Further shown is closed ended enclosure 1, with push-button plungere 2, inserted in the open end, and distanced, aligned holes 4, and 5, transversing both, at right angles to their length.

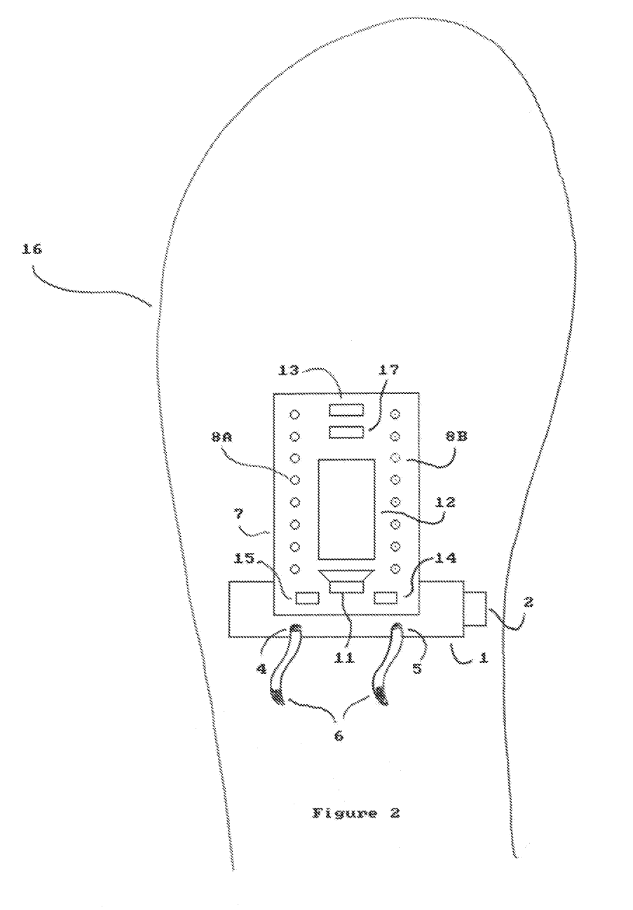

FIG. 2, shows enclosure 1, housing push-button plunger 2, both of FIG. 1, and opposite ends of shoe strings 6, respectively threaded through distanced, aligned holes 4, and 5.

The pressure exerted by expanding compression-expansion spring 3, when push-button plunger 2, both of FIG. 1, is manually released, offsets the respective distanced holes 4, and 5, between enclosure 1, and push-button plunger 2, causing a pinching effect, which holds each end of threaded through shoe lace 6, in place, after being pulled taunt, and thereby secures shoe 16, on the foot of a wearer.

Attached to enclosure 1, of FIGS. 1, and 2, is platform 7, with light emitting diodes in rows 8A and 8B, in addition to loud speaker 11, loud speaker echo chamber 12, microphone 17, and function switches 13, 14, and 15.

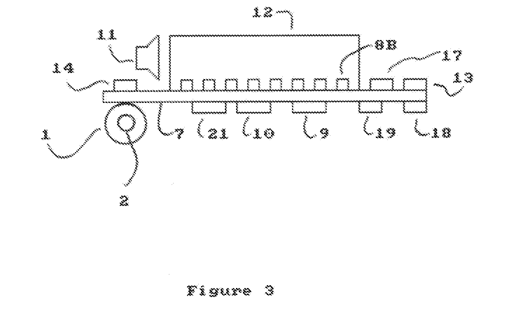

FIG. 3, shows a profile of enclosure 1, and push-button plunger 2, both of FIGS. 1, and 2, with enclosure 1, attached to platform 7, of FIGS. 2, and 3, hosting a row of light emitting diodes 8B, sound record and playback module 9, wireless communication transceiver 10, microphone 17 loud speaker 11, loud speaker echo chamber 12, battery 19, solar cell 21, data processor 18, and function switches 13, and 14.

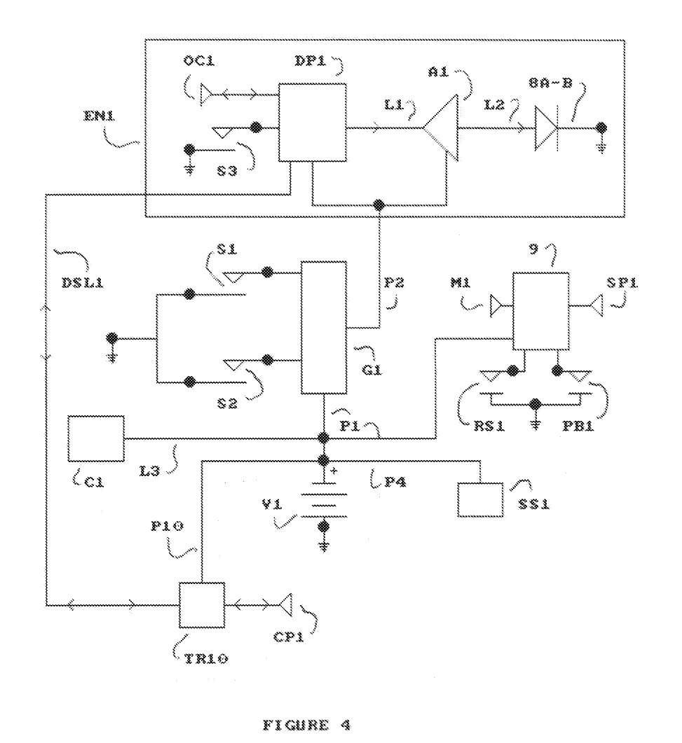

FIG. 4, shows a block diagram of circuitry hosted on platform 7, of FIGS. 2, and 3.

Contained in enclosure EN1, is data processor DP1, whose signal dries light emitting diode, 8A-B, through signal line L1, amplifier A1, and signal line L2.

Switch S1, when activated, enables gate G1, to energize the circuitry of enclosure EN1, from battery V1, through respective power lines P1, and P2, and additionally from solar cell SS1, through power lines P4, P1, and P2.

Further shown is wireless communications transceiver TR10, energized by battery V1, through power line P10, and through power lines P4, and P10, by solar cell SS1.

Bi-directional wireless communication port CP1, is hosted by radio frequency transceiver TR10, which is connected through bi-directional data but line DSL1, to data processor DP1.

Bi-directional wireless port OC1, of data processor DP1, is a direct communications venue of data processor DP1.

Switch S2, of gate G1, when momentarily closed, turns off all operational voltage sourced from battery V1, and solar cell SS1, to encoding data processor DP1, amplifier A1, and light emitting diode 8A-B, all if enclosure EN1.

Activation of switch S3, enables a data processor DP1, algorithm to hold light emitting diode 8A-B, illuminated continuously.

Battery charger C1, is connected to rechargeable battery V1, through power line L3.

The source of power for battery chargeer C1, is any sustaining external direct current voltage, of the proper level and polarity.

Further shown in FIG. 4, is sound module 9, with recording microphone M1, loud speaker SP1, record switch RS1, and playback switch PB1, all of FIGS. 2 and 3.

Sound module 9, is a commercially available product, with like devices available from multiple sources, including Novoton Technology.

Power to sound module 9, is sourced through voltage line P1, from battery V1, and solar cell SS1, through voltage lines P4, and P1.

### IN CONCLUSION

The implementation of concepts described and depicted herein, are just one example of several means to accomplish the end results claimed for this invention.

What is claimed:

1. A means to eliminate bow tie knotting of a foot apparel lace with a pinching appliance, which further hosts a platform, that supports a multi-function means of communication; to include a microphone, for feeding a modulated analog signal over a hard-wire connection to a system comprising: an audio storing semiconductor memory, to record at least one sound, responsive upon activating a resident record switch, and an audio playback from the same audio storing semiconductor memory, upon activation of a resident playback switch, which causes an amplified audio, pre--recorded, transmission to a loud speaker, through a hard-wire connection, with audio emanations simultaneously directed from the loud speaker into an on-board echo chamber.

2. The invention of claim 1, comprising a platform, holding a microphone, a system of at least one amplifier, an audio storing semiconductor memory, an audio record-playback control circuit, hosting an audio record switch, and an audio playback switch, with a hard-wire connected loud speaker, feeding an audio echo chamber in close proximity, in addition to a radio frequency transceiver, a data processor, a battery, and solar cell power source, and at least one light emitting diode.

3. The invention of claim 1, hosting at least one timer to modulate at least one light emitting diode, on and off.

4. The invention of claim 1, whose pinching appliance is comprised of a fixed length enclosure, hosing an internal compression-expansion spring, located at a closed end, and a plunger of a specific length inserted at the opposite, open end, extending outward from the body of the enclosure, a sufficient fixed distance, to form a combination user operated push-button plunger, with the enclosure and the hosted push-button plunger, each accommodating two distanced holes located at right angles to their lengths, which come into alignment with their counterpart, when the push--button plunger is pressed inward, against the pressure of the internal compression-expansion spring, enabling a clear path for opposite ends of a foot apparel lace to be freely threaded through, with the lace, when pulled taunt, held in that state, by a pinching effect, after the respective holes become offset, due to the compression-expansion spring pressuring the push-button plunger outwardly, when it is manually released, to assume a resting position, as a means of securing a foot apparel, in place, on a wearer.

5. The invention of claim 1, powered by a resident photo-voltaic cell.

6. The invention of claim 1, powered by a resident rechargeable battery.

7. The invention of claim 1, hosting at least one light emitting diode, radiating at least one visible color.

8. The invention of claim 1, hosting at least one light emitting diode, radiating in the non-visible portion of the spectrum.

9. The invention of claim 1, comprising means of light emitting diodes configured to display geometric patterns.

10. The invention of claim 1, comprising means of light emitting diodes configured to display graphics.

11. The invention of claim 1, hosting at least one light emitting diode, as a medium of communication.

12. The invention of claim 1, comprising means of optical communications.

13. The invention of claim 1, comprising means of communicating wirelessly with another like device, using the radio frequency spectrum.

14. The invention of claim 1, comprising means of data communications, controlled by at least one resident data processor algorithm.

15. The invention of claim 1, hosting at least one light emitting diode, comprising means to emit an encoded signal by means of a data processor directed algorithm.

16. The invention of claim 1, hosting at least one radio frequency wireless transceiver, communicating an encoded signal, with another like device, by means of a data processor algorithm.

17. The invention of claim 1, comprising means of data processor programmability from an external source through a hosted communications port.

18. The invention of claims 1, and 4, transferable from at least one type of foot apparel to at least one other type of foot apparel.

19. The invention of claims 1, and 4, hosting displayed graphics.

20. The invention of claims 1, and 4, hosting articles of adornment.
